(19) United States
(12) Patent Application Publication
(10) Pub. No.: US 2017/0039222 A1
(43) Pub. Date: Feb. 9, 2017

(54) METHOD AND SYSTEM FOR COMPARATIVE DATA ANALYSIS

(71) Applicant: FARROW NORRIS PTY LTD, Hurtsville, New South Wales (AU)

(72) Inventor: James Matthew FARROW, Hurtsville, New South Wales (AU)

(21) Appl. No.: 15/305,335

(22) PCT Filed: Apr. 29, 2015
(86) PCT No.: PCT/AU2015/000251

§ 371 Date: Oct. 19, 2016

(30) Foreign Application Priority Data
Apr. 29, 2014 (AU) 2014901541

(51) Int. Cl. G06F 17/30

(52) U.S. Cl. CPC G06F 17/30241; G06F 17/30477

(57) ABSTRACT

Embodiments of the present invention provide a method and system for comparative analysis of data records. In particular embodiments of the present invention enable a computer system to provide a template lattice as an input to computer implemented abstraction of data from records for comparative analysis, abstract record data, map one or more record data elements to a mapped position, determine a plurality of lattice elements and a set of lattice element identifiers associated with the plurality of lattice elements to provide a characterising set for the mapped position and compare first and second data records in order to determine the degree of similarity between a first characterising set and a second characterising set for the respective first and second records. The method and system can be utilised to allow comparative analysis of recorded data that may be sensitive for the individual subjects while preserving privacy of the individual subjects.

### TECHNICAL FIELD

The technical field of the present invention is methods and systems for abstracting or encrypting data to enable comparative analysis of the data, in particular enabling comparative analysis of data in encrypted or abstracted form. An example of an application of an embodiment of the invention is determining a distance between two locations without providing precise location data to maintain privacy of this information.

### BACKGROUND

Maintaining individual privacy is important, particularly when dealing with sensitive data. For example medical health data is highly valuable to researchers while also being very sensitive data for the individual patients. Individual patients may allow their data to be utilised for research purposes provided they, as individuals, remain anonymous to the researchers. Thus typically there is a trade-off between the amount of socio-demographic information to be removed and that which is retained or encoded in medical records being used for research purposes since socio-demographic data such as name, age, gender, location, ethnicity etc. is often of great value for the research being undertaken and for making useful comparisons between records. The situation can arise where there is a trade-off between privacy and usefulness. When dealing with such sensitive data individual privacy is very important. Any approach which can retain privacy and increase usefulness is significant. This can be especially true of location information. Location information can be valuable simply for looking at the distance people travel to receive care or for more detailed analysis such as identifying geographical “cluster” effects or distribution patterns for health concerns such as communicable diseases or environmental influences. To date many mechanisms hand out exact locations for purposes such as comparison, which then makes the data highly sensitive because it may readily allow re-identification of the underlying individuals.

Known methods aiming to maintain privacy of location information include:
Aggregating or generalising location data using larger regions, such as census districts, postcodes, local government areas etc. This has the disadvantage of introducing a level of imprecision in the data as the location is now approximate. The smaller the regions the less the imprecision, but this moves closer to the situation where exact locations are handed out again.
Grouping records so that no fewer than k elements share each group to help preserve anonymity. Such as scheme might provide variable sized regions but is still imprecise and may not be a workable option in the face of sparse data.
‘Jittering’ the location data by adding a random vector so the distributed location is still approximately in the right position but not in the exact position. For statistical purposes in the aggregate this may still give acceptable results but individual data points no longer exactly represent the correct underlying position.

Replacing geographical identifiers in data can be replaced with pseudonyms, however this causes information loss. Different methods for generating pseudonyms for geographical information have been suggested, however distance calculations performed with these identifiers usually implies large margins of errors.

A common problem with the above approaches is a trade-off between accuracy of comparison and degree of anonymity.

Another alternative is to hand the responsibility for comparison to a (trusted) third party which only receives record identifiers and socio-demographic data such as locations but does not receive any sensitive data. The third party performs record-to-record comparisons and returns difference and or similarity measures between records identified only by identifier without knowing anything else. The data recipient then receives the computed comparisons between records rather than any explicit location or other socio-demographic data. This can have the disadvantage of extra time, cost and overhead for researchers, which often cannot be afforded.

As a further alternative, aspects of the data to be compared, such as date elements or letter pairs, can be abstracted over using a one way hash into a bitset which sets 1 or more bits for each element abstracted. This approach can be rigid in terms of matching as it wholly identifies a match or not of each component element with the same weighting. Some subset of the elements might match but each conceptually matches wholly or not at all, there is little control over identifying partial or less good matches such as detecting a match between two dates where the day and month have been transposed, e.g. Apr. 4, 1998 and May 4, 1998 and detecting these as better than just the year matching but less good that a perfect match of all three components. There is a need to identify such partial matches.

There is a need for alternative methods for enabling comparison of data with a high degree of accuracy while minimising the risk of individual anonymity being compromised.

User location is also becoming increasingly utilised in social networking and marketing. However, many individuals wish to have some control over the extent to which their location is known or can be determined from information published on-line or otherwise available through networked services. Currently, there is an “all or nothing” approach taken by most suppliers of services, where a user must enable use of their exact location (for example based on acquired GPS coordinates or network access information) or forego access to location based services. For individuals concerned about malicious use of their location information they have to trade off their desire for services with desire for privacy security.

### SUMMARY OF THE INVENTION

According to a first aspect of the present invention there is provided a computer implemented method of comparative analysis, the method comprising the steps of:

providing a template lattice as in input to computer implemented abstraction of data from records for comparative analysis, the template lattice comprising a pattern of lattice elements defined using an n-dimensional coordinate system, wherein each lattice element is assigned an identifier independent of the coordinate system;

abstracting data from each record for comparative analysis by a data abstraction module preforming the steps of:
mapping one or more record data elements to a mapped position using the coordinate system; and
determining a plurality of lattice elements within a geometrically defined area of the lattice surrounding mapped position and a set of lattice element identifiers associated with the plurality of lattice elements to provide a characterising set of for the mapped position;

comparing a first data record and a second data record by a record comparison module performing the steps of:
determining the degree of similarity between a first characterising set for the first record and a second characterising set for the second record; and
translating the degree of similarity to a comparison measure between the first record and second record based on the geometrically defined area used for abstracting data.

In an embodiment the step of providing the template lattice comprises:

providing an n-dimensional coordinate system;

defining a lattice using the coordinate system where each lattice element is defined by a set of coordinates; and assigning an identifier independent of the coordinate system and unique for the template lattice to each lattice element to provide the template lattice comprising a set of lattice elements, where each lattice element is defined by a set of coordinates corresponding to a position of the lattice element within the lattice and a lattice element identifier.

In some embodiments the n-dimensional coordinate system is an application specific coordinate system wherein for at least one dimension coordinates of the one dimension correspond to a set of a plurality of possible non-numerical values for a data element enabling non-numerical values to be transposed to numerical values for geometrical analysis. In some embodiments n is greater than one.

An embodiment may further comprise the step of changing the lattice element identifiers of the template lattice to provide a further template lattice.

In an embodiment the lattice is a regular lattice where each lattice element is equidistant in each of the n dimensions from neighbouring lattice elements.

In an embodiment the lattice is a regular lattice where each lattice element is equidistant with respect to some of the n dimensions from neighbouring lattice elements.

In an embodiment the lattice element identifiers are generated using a random or pseudo random number generator.

In an embodiment the template lattice is a two dimensional lattice and the geometrically defined area used for characterizing a mapped position is a circle of a fixed radius.

In some embodiments the geometrically defined areas, volumes or other shapes used for characterizing a mapped position need not be regular or connected within the coordinate space and the areas, volumes or other shapes may be of different sizes within the space.

In some embodiments the abstracting step further comprises an initial step of transposing values of the one or more data elements to values mappable using the coordinate system.

In some embodiments the abstracting step further comprises a step of encrypting the set of lattice element identifiers using a one-way encryption function provide a characterising string for the one or more record data elements, and the degree of similarity of the first characterising set and second characterising set is determined by comparing the encrypted strings of the first characterising set and the second characterising set. For example, in some embodiments the one-way encryption function is a hashing function outputting the characterising string as a bit string. The step of comparing the encrypted strings can comprise performing a logical AND function.

In an embodiment the abstracting step comprises a further step of encoding the characterising set using a reversible encoding and or compression function and the step of comparing a first data record and a second data record comprises and initial step of decoding the encoded characterising set for each of the first and second records.

In an embodiment the abstracting step comprises a further step of encoding the characterising string using a reversible encoding and or compression function and the step of comparing a first data record and a second data record comprises and initial step of decoding the encoded characterising string

In an embodiment the n-dimensional coordinate system is a coordinate system is a spatial or geographical coordinate system and the degree of difference between the first record and second record is translated to a distance between a first spatial or geographical position and a second spatial or geographical position. This embodiment may further comprise the step of performing distance correction of the translated distance by applying a correction function. The correction function may be a linear scaling correction.

According to another aspect of the present invention there is provided a system for comparative analysis, the system comprising:

a data abstraction module configured to abstract data of an input record based on a template lattice comprising a pattern of lattice elements defined using an n-dimensional coordinate system, wherein each lattice element is assigned an identifier independent of the coordinate system, by mapping one or more record data elements to a mapped position using the coordinate system, determining a plurality of lattice elements within a geometrically defined area of the lattice surrounding mapped position and/or otherwise related to the mapped position and a set of lattice element identifiers associated with the plurality of lattice elements to provide a characterising set; and

a comparator module configured to compare a first data record and a second data record by, determining a degree of similarity between a first characterising set for the first data record and a second characterising set for the second data record; and

a translator module configured to translate the degree of similarity output from the comparator module to a comparison measure between the first record and second record based on the geometrically defined area used for abstracting data.

In an embodiment the system further comprises a template lattice generator configured to define a lattice using a provided n-dimensional coordinate system where each lattice element is defined by a set of coordinates equidistant in each of the n dimensions from neighbouring lattice elements, and assign to each lattice element an identifier independent of the coordinate system and unique within the lattice to provide a template lattice comprising a set of lattice elements, where each lattice element is defined by a set of coordinates corresponding to a position of the lattice element within the lattice and a lattice element identifier.

In some embodiments the lattice generator may be configured to produce a lattice where lattice elements are equidistant with respect to only some subset of the total number of coordinates comprising the dimensionality of the lattice (as opposed to along all coordinate axes).

In an embodiment the data abstraction module is further configured to encrypt the characterising set of lattice element identifiers using a one-way encryption function provide a characterising string for each of the one or more record data elements, and the comparator module is configured to determine a degree of similarity between the first characterising set and second characterising set by comparison of the characterising strings.

An example of an application of an embodiment of the invention is determining a distance between two locations without providing precise location data to maintain privacy of this information.

Another example of an application of an embodiment of this invention is to perform probabilistic/weighted record linkage (where one or more sets of records are analysed to determine similar records and the degree of similarity) while maintaining a possibly enhanced level of privacy over the data in the records involved.

### BRIEF DESCRIPTION OF THE DRAWINGS

An embodiment, incorporating all aspects of the invention, will now be described by way of example only with reference to the accompanying drawings in which

FIG. 1 is an example of a block diagram of a system in accordance with an embodiment of the invention

FIG. 2 is a flowchart of an example of a data abstraction process in accordance with an embodiment of the invention

FIG. 3 is a representation to illustrate data abstraction based on geometric area

FIG. 4 is an example of a characterising set of data abstracted using an embodiment of the invention

FIG. 5 is an example of a comparison process in accordance with an embodiment of the invention

FIG. 6 is a representation to illustrate overlap of geometric areas

FIG. 7 is a representation to illustrate a simple example of overlapping areas

FIG. 8 is a representation of the example of FIG. 7 mapped to a two dimensional template lattice of grid points.

FIG. 9 is a representation of axes for a three dimensional lattice embodiment mapping data in three dimensions illustrating data encoded using lattice identifiers from a spherical region

FIG. 10 illustrates a concept of filtering within the lattice of FIG. 9

FIG. 11 illustrates a two dimensional lattice overlaying a map of the coastline of NSW for a worked example calculating the distance between Sydney and Wollongong on the basis of overlapping grid points in accordance with an embodiment of the invention.

### DETAILED DESCRIPTION

Embodiments of the present invention provide a method and system for comparative analysis of data records. In particular embodiments of the present invention enable a computer system to abstract record data and perform comparative analysis of abstracted data records. The method and system can be utilised to allow comparative analysis of recorded data that may be sensitive for the individual subjects while preserving privacy of the individual subjects.

An embodiment of the present invention provides a computer implemented method of comparative analysis. A template lattice is provided as an input to computer implemented abstraction of data from records for comparative analysis. The template lattice comprises a regular or irregular pattern of lattice elements defined using an n-dimensional coordinate system. Each lattice element is assigned an identifier independent of the coordinate system.

Data from each record for comparative analysis is abstracted by mapping one or more record data elements to a mapped position or positions using the coordinate system, a plurality of lattice elements within a geometrically defined area of the lattice surrounding the mapped position(s) is then determined. A set of lattice element identifiers associated with the plurality of lattice elements then provides a characterising set for the mapped position(s).

A first data record and a second data record can then be compared based on the degree of similarity between the characterising sets for the data of each record. The degree of similarity corresponds to the amount of overlap of the geometric areas characterising the data of the first and second records.

Embodiments of the present invention perform comparative analysis of data based on geometric principles, wherein data is characterised based on a geometrical area or volume surrounding a position or positions for the data, mapped using an n-dimensional coordinate system. Two or more data records are compared based on the overlap of the geometric areas or volumes surrounding the mapped position(s) for each record to determine a degree of similarity or difference between the record data. As the comparison and degree of similarity is determined based on geometric overlap knowledge of the precise nature of the underlying data is not necessary to make the comparison. The overlap can be translated to a distance/difference between the two records based on knowledge of the coordinate system and geometry of the area surrounding mapped position rather than needing reference to the actual mapped position. For example, in an embodiment intersecting sets of grid points (ISGP) are used to approximate distances between locations mapped to a grid.

Further, in some embodiments, as the comparison is based on overlapping areas it is not necessary to be able to recover the original mapped position, so one way abstraction or encryption which preserves the ability to determine overlap of records but does not allow direct recovery of the mapped position can also be used.

The invention provides a manner by which an automated system, for example implemented using a combination of any one or more of software, firmware and hardware, can abstract and comparatively analyse data sets. Further, embodiment of the invention can provide abstracted record data for comparison in a format that inhibits recovery of the original data purely from the data in abstracted form by either a person or a computer system. For example, without knowledge of the underlying abstraction method and template lattice recovery of the original data may be impossible or require excessive processing resources, making data recovery unfeasible, highly impractical, or economically unviable. In some embodiments, even with knowledge of the underlying abstraction recovery of the original data with a high degree of certainty may be impossible. Thus, embodiments of the present invention can be used for enabling comparative analysis of data sets while maintaining a relatively high degree of privacy of the original data.

Embodiments utilise the capability of computer systems to process and record large data sets and perform pattern matching of data sets.

An embodiment of the present invention provides a computer implemented method of comparative analysis. A template lattice is provided as an input to computer implemented abstraction of data from records for comparative analysis. The template lattice comprises a regular or irregular pattern of lattice elements defined using an n-dimensional coordinate system. Each lattice element is assigned an identifier independent of the coordinate system. The template lattice can be pre-prepared and input to the system or generated by the computer system. Generation of a template lattice will be described in more detail below.

For an aid to understanding, in a two dimensional exemplary embodiment the lattice can be a regular grid with each grid point assigned an identifier. Record data elements are mapped to the grid and characterised using a set of grid point identifiers within an area surrounding the mapped point (for example a circle of fixed radius around the mapped point). Comparison between mapped data elements can be made based on intersecting sets of grid points by identifying common grid point identifiers in the characterising sets. As an example, consider the approximation of the distance between two spatial points, in two dimensional space, without using information about their exact positions. For this purpose we approximate the area of intersection between two circles surrounding these points.

As illustrated in FIG. 7, consider two points, P 710 and Q 720 separated by a distance d 730. We use each point as the centre of a circle with radius R 740. Up two a point where the circles are just touching, i.e. for 0≦d≦2R, the two circles overlap and have an area of overlap of A 750 which is related to d 730. Over the domain 0≦d≦2R there is a bijection (a one-to-one and onto relationship) between the distance d and the area of overlap A. Every value of 0≦A≦πR² corresponds to exactly one distance 0≦d≦2R between P and Q. The bijection is between d:[0,2R] and A:[0, πR²]. This is described by Equation 1 showing the relation between d and A.

$$f \text{:} [ 0 , 2 R ] -> [ 0 , π {R}^{2} ] , d -> A ( d ) \\ A ( d ) = 2 {R}^{2} {cos}^{- 1} ( \frac{d}{2 R} ) - \frac{1}{2} d \sqrt{4 {R}^{2} - {d}^{2}} \qquad Equation [ 1 ]$$

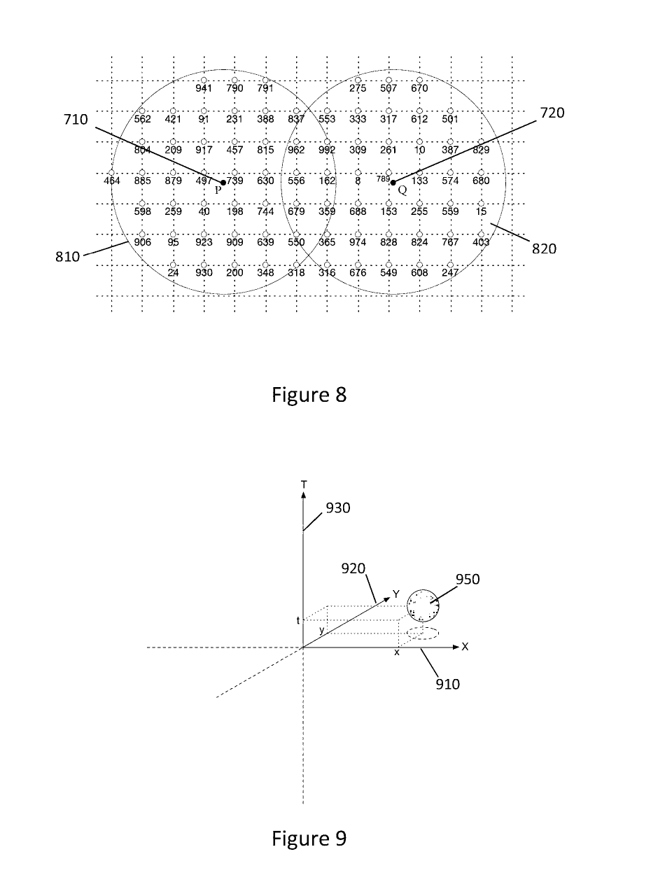

Employing this concept in the context of the present example, overlay the two circles with a grid of points, shown in FIG. 8, and label each grid point with a unique random identifier, in this case, random numbers. For each central point P and Q take a characterising set of points consisting of the grid points surrounding each central point contained within the respective circle constructed on each central point with radius R. Take G_{P} 810 as the characterising points for P 710 and G_{Q} 820 as the characterising points for Q 720. We can then determine the subset of points covered by the area of intersection A as the set of grid points given by G_{P}∩G_{Q}. In FIG. 8 G_{P}∩G_{Q}={962, 992, 556, 162, 679, 359, 550}.

Similar distances between points being compared give rise to approximately the same cardinality of the intersection set of points (approximately the same number of points enclosed by the intersection of the circles) when the grid is regular and the radius is suitably larger than the grid resolution. The similarity of the two characterising sets corresponding to P and Q can be calculated using an appropriate similarity metric. The Sørensen-Dice coefficient is one such metric defined in Equation 2.

$$s = \frac{2 \vert {G}_{P} ⋂ {G}_{Q} \vert}{\vert {G}_{P} \vert + \vert {G}_{Q} \vert} \qquad Equation [ 2 ]$$

where the |S| operator returns the number of points in the set S. This similarity metric can give an approximate area of intersection A as a proportion of the total area of the circle πR² by using Equation 3.

Â=s·πR² Equation [3]

Taking this result and substituting into A(d)=Â and solving gives an approximation for the distance d between P and Q.

Data from each record for comparative analysis is abstracted by mapping one or more record data elements to a mapped position or positions using the coordinate system, a plurality of lattice elements within a geometrically (or otherwise) defined area of the lattice surrounding the mapped position(s) is then determined. A set of lattice element identifiers associated with the plurality of lattice elements then provides a characterising set for the mapped position(s).

Determining the degree of similarity between the characterising sets for two data records can be done by determining the number of elements in common. For example, where the characterising set is simply the characterising sets of lattice element identifiers, the degree of similarity may be the number of lattice element identifiers in common. This similarity corresponds to the amount of overlap between the two geometric areas characterising the data of the first and second records. This degree of similarity may be a useful measure in itself. Alternatively, knowledge of the area of overlap can be translated into a meaningful measure based on knowledge of the geometry of the characterising areas and the underlying lattice. For example, in an application of an embodiment of the invention the data to be compared from a first and second record may be location data, the precise locations from each of the records can be characterised as described above, and the overlap between the records translated into a distance between the two locations, without need to know the precise original locations to make this comparison.

In some embodiments the characterising set of lattice element identifiers can be encrypted using a one-way encryption function to provide a characterising string for the one or more record data elements. This can further obscure the original data and in some embodiments also reduce the size of the characterising set to enable more efficient analysis. In the context of the present invention a one-way encryption or compression function is a function which performs a conversion on the original data that cannot be reversed to recover or recreate the original data. For example, as a result of the one way encryption/compression some data is deleted meaning the original data cannot be recovered with any certainty. Alternatively decision trees may be employed for the encryption/compression which cannot be traced back to recover the original data.

The characterising strings of two records can be compared to determine the degree of similarity, which, in turn, can be translated to a meaningful measure of the difference between the compared data records. Depending on the one way encryption function used, the degree of similarity may be equivalent to a direct comparison of the characterising strings of lattice identifiers and identification of common elements based on encrypted patterns. Knowledge of the encryption used, regular pattern of lattice elements and geometrical definition of the geometrically defined area used for abstracting data can enable degree of similarity to be translated to a measure of difference between the first record and second record.

The template lattice may be prepared and provided for use in abstracting and comparing data or generated. To generate a template lattice first a coordinate system is chosen or created, the coordinate system will have n dimensions and typically n will be two or greater. A lattice is defined using the coordinate system, where each lattice element is defined by a set of coordinates equidistant in each of the n dimensions from neighbouring lattice elements. Each lattice element is then assigned an identifier independent of the coordinate system and unique within the lattice to provide a template lattice comprising a set of lattice elements, where each lattice element is defined by a set of coordinates corresponding to a position of the lattice element within the lattice and a lattice element identifier.

It should be appreciated that a geometric area can be defined in the lattice using the coordinate system and the lattice elements within that geometric area determined. As each lattice element has a unique identifier overlap of two geometric areas on the lattice can be determined based on common lattice element identifiers alone, without requiring the lattice element coordinates. Thus, the coordinate information can be discarded. To further obscure the original data the set of lattice element identifiers for each record can undergo one way encryption to provide a characterising string. This encryption may also reduce the size of the string to reduce data storage, transmission and processing requirements and may also simplify data comparison.

It should be appreciated that embodiments may be used to abstract information to be compared as regions of n-dimensional space. The n dimensions may represent any aspect of the record data. This may require an additional step of translating record data which is non-numeric or non-linear onto a scale to define coordinates in a dimension. For example, text based quantifying data may be mapped to a linear numerical scale to facilitate mapping of the data to a geometrical position. The requirement that all lattice elements be equidistant may also be relaxed for some (or all) of the dimensions.

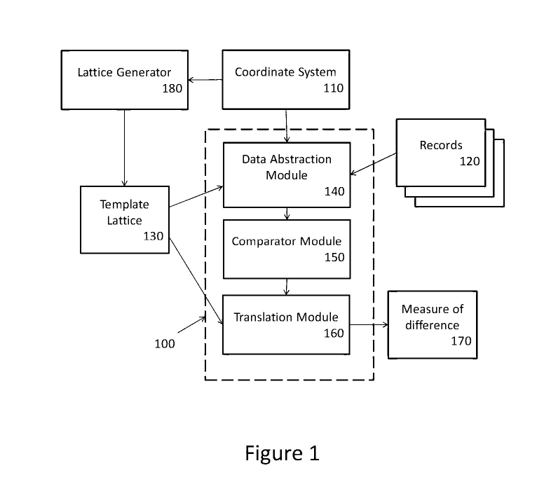

An example of a high level block diagram of a system for implementing the method described above is shown in FIG. 1. The embodiment of the system 100 shown comprises a data abstraction module 140, comparator module 150 and a translation module 160 and inputs to the system are a coordinate system 110, template lattice 130 and records 120 for analysis. Embodiments of the system may also include a lattice generator 180, but it should be appreciated that the template lattice may simply be externally generated and provided to the system for use along with the coordinate system 110.

The system 100 can be implemented using any suitable combination of hardware, software and firmware. At a broad level, the system can be implemented a as function of a broader system, for example an embodiment can be implemented within a computer system comprising an interface for receiving user instructions and displaying results, and a processor for executing user commands and programmed instructions, including commands to receive record data in a suitable manner for processing. The computer system may be implemented by any computing architecture, including stand-alone PC, client/server architecture, “dumb” terminal/mainframe architecture, or any other appropriate architecture. The computing system is appropriately programmed to implement the embodiment described herein. Records may be input to the system or retrieved from a database. In an embodiment, there is provided a local database containing data records. In another embodiment, it will be understood that the system may access a separately located and/or administered database containing data records. The database may be separately administered by a Government authority or third party. The system can be implemented as a module having functionality accessed and utilised by other system applications. For example, an embodiment may be implemented in a smart phone as a location obfuscation module accessed by social media applications in response to a user input in the social media application, to allow a user to determine or share relative closeness to others users or landmarks without needing to provide exact location information.

The individual system modules 140, 150, 160, 180 may also be implemented as a plurality of stand-alone modules, implemented using different hardware and configured for data communication between the modules whereby the output of one module is input to the next for processing. Embodiments may be implemented using dedicated hardware processors or programmable hardware for one or more modules, for example ASIC (application specific integrated circuits), FPGA (field programmable gate arrays), dedicated microprocessors or programmable logic controllers, such hardware implemented embodiments may be appropriate for applications were high processing speed is desirable whereas software based embodiments may be more desirable where a high degree of reconfiguration is required. Embodiments may use combinations of software and hardware to implement different system components. For example, an abstraction module and comparator module may be provided in a software application executable on a mobile device such as a mobile phone and the application be provided with a template lattice via a communication network, the template lattice being generated by a lattice generator module on an external, network accessible server, thus simplifying the implementation an processing required on the mobile device. Such an application may be used for comparing the position of two mobile devices using abstracted position data transmitted between the two devices rather than actual position data. Examples of specific embodiments will be discussed in further detail below.

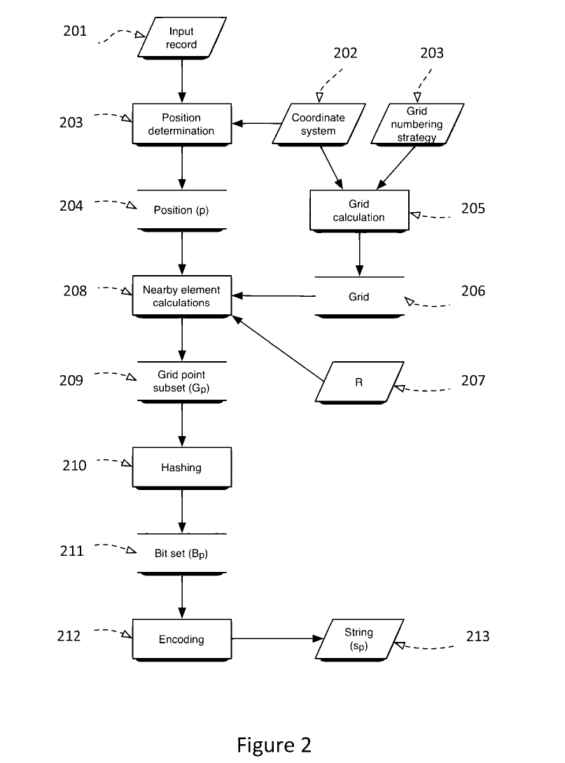

An example of a process of abstracting data records for comparison in accordance with an embodiment of the invention will now be discussed with reference to FIG. 2. An input record 201 containing information to be compared has ‘position’ information p 204 extracted from it using a position determination process 203 with relation to a particular coordinate system 202. The position determination process 203 may be a simple mapping process where the data can be readily mapped using the coordinate system. For example, where the coordinate system is a geographic positioning system, for example global positioning system (GPS) and the input record contains location data defined by GPS coordinates, then this position may be readily mapped. Where the location data is street address data this may be converted to GPS coordinates. Alternatively, position determination may involve normalising the individual components of the data which ultimately result in values along axes of the coordinate system which are comparable for a particular value of R 207, R being a constant input for determination of a geometric area surrounding a mapped point p. For example, this normalisation may involve conversion of non-linear or non-numerical data to a value on a numerical scale or set of numerical values to facilitate mapping the data to a geometric position. For example, a parser may be configured to convert record data (linear or non-linear, numerical or non-numerical) into numerical data for mapping to a position on the template lattice. The data conversion of translation performed by the parser may be specific for a particular set of data records, for example to convert a set of text based data to numerical values for representation as sets of coordinates. This position information may be spatial coordinates pairs such as (x, y) coordinates or (latitude, longitude) coordinates or abstract coordinates in some other space. The space may have other than 2 dimensions (for example 1, 3, 4, 5 or more dimensions). R may be a vector comprised of separate values for each coordinate axis not all (or any) of which may be used.

The number of dimensions used may be limited to data storage and processing capacity of the system. Provided the system resources are available to support the data processing any number of dimensions may be used. The number of dimensions used in practice will typically be determined based on the number of variables of interest for the comparative analysis provided this number of dimensions can be supported by the data processing capacity. Although examples of the invention have been described with reference to visual representations of the overlapping data sets, a skilled person should appreciate that visual representation is not necessary and in some applications even undesirable, so ability to visually represent the template lattice and mapped data is not a requirement or limitation for embodiments of the invention. However, some embodiments may include display of mapped data and/or representations of comparative analysis results.

The coordinate system 202 has overlaid upon or within it a template lattice which is a regular ‘grid’ or ‘lattice’ (or ‘n-dimensional lattice’) 206 prepared using a process 205 such that when necessary for geometric comparison equal area/volume/hyper-volume regions of the space described by the coordinate system encompass a commensurate number of grid cells or points. This division process might be equal subdivision of a Cartesian plane or a regular triangular subdivision of the Earth's surface or a regular volume division of a 3-dimensional space or a regular division of an n-dimensional space. The lattice elements are assigned identifiers using a numbering strategy 202a, e.g. random identifiers. Thus, the template lattice G comprises a regular lattice of cells or points, each assigned a lattice element identifier.

The position p 204 corresponds to a data element mapped with respect to the coordinate system 202. The position p 204 has a set of ‘nearby’ lattice elements determined Gₚ 209 using a process 208 that calculates ‘nearby’ grid cells or points, for example using a maximum nearby radius scalar or vector R 207 or using decisions embodied within the process possibly affected by the values in R. The dimensionality of R need not be n.

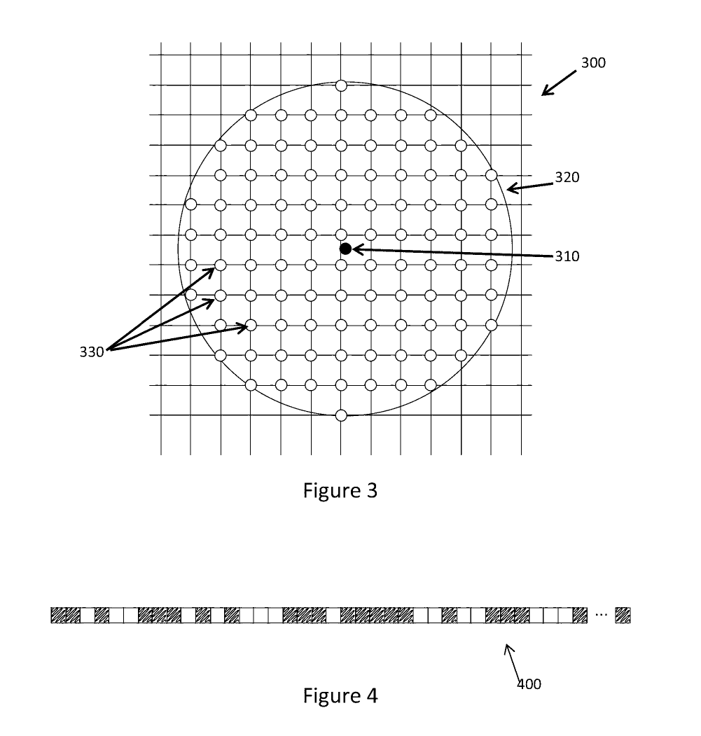

In two dimensional space, for example, with reference to FIG. 3, to encode a given spatial location p310, draw circle 320 of radius R around p310. Overlay this on a grid G 300 of nearby points g₁, g₂, g₃, . . . , gₙ that have been assigned random identifiers, and take the set of points 330 which lie inside the circle Gₚ.

For example, in FIG. 3 the points 330 which lie within the circle might be {2764, 76, 654, 1028, 372, 4298, 14120, 22502, 21508, 276, 15767, 13434, 6705, 15217, 12586, 16055, 5840, 19572, 23841, 15936, 17062, 20580, 2548, 20516, 12610, 17261, 20681, 2, 2677, 3434, 6673, 22917, 17352, 23642, 6053, 420, . . . }.

In this example a one-way ‘hashing’ function 210 is used to assign a corresponding element from a bitset (usually with a smaller number of elements) to each element of this larger identifier set 209. The resulting bit set Bₚ 211 has a bit (or bits) set for each identified lattice point in 209. Multiple points in the lattice 206 and hence multiple points in the lattice subset 209 may or may not hash to the same bit(s) in 211.

Using such a ‘hashing’ function in this manner gives a more manageable and ‘anonymised’ set of points that may be provided without disclosing the original position p. Two bit sets can be compared to determine a degree of similarity between the two sets. Although individual elements may ‘collide’ (exist in the set) when two circles don't overlap, for sufficiently large target hash sets the chance of a meaningful collision is small. Take the larger set Gₚ and calculate B(Gₚ)→Bₚ being the resulting set of bits representing point p in by setting some of the bits b₁, b₂, . . . , bₙ in a smaller set B, e.g. the function taking gₙ to bₙ being which bit to set in the resulting array might be as simple as gₙ mod |B| or it may be a more complex hashing function. Multiple bits may be set per nearby point. A representation of a bit set Bₚ 400 is shown in FIG. 4.

These bits Bₚ, may be further encoded or encrypted in various ways using an encoding process 212 resulting in a transmission-safe encoded string sₚ (for varying transmission needs), e.g. base64 to give strings of characters which represent the underlying bits, e.g. the strings ‘qyishu58sg5ngu8kq1meexut01ooiup27ylkmm4t1mny09k1smrxqh3v43yuldo43xebqbf4 4d0x3c795rvw13ib3nf2nopahbygapvqk7hgu6gk63ufgccp5wlg8umzulczd8dwmfxcgj05q 1gigp4sy3khrpej09fi2uzur6vlvq49vb78lj9d89d64f1njrrg23’ and ‘q7vwm9aezlptqkhyrsn6h5s5vpomltxk1e5a7jbah45edqd2upcorstnrzkvrujddi4pncoashq swhyk701135ik689q71legdci235vjgns85c1legs76mat9fqkxwt0fjs3lgnjlujov0iujcsp6uv0u 2yg5aqmna1wlirxcubp0hsmwwdcf4u1ofwtnx00t4lv2’ might be compared to ascertain the points they represents are some distance apart, say 115 km but without revealing exactly where they are only their relative separation.

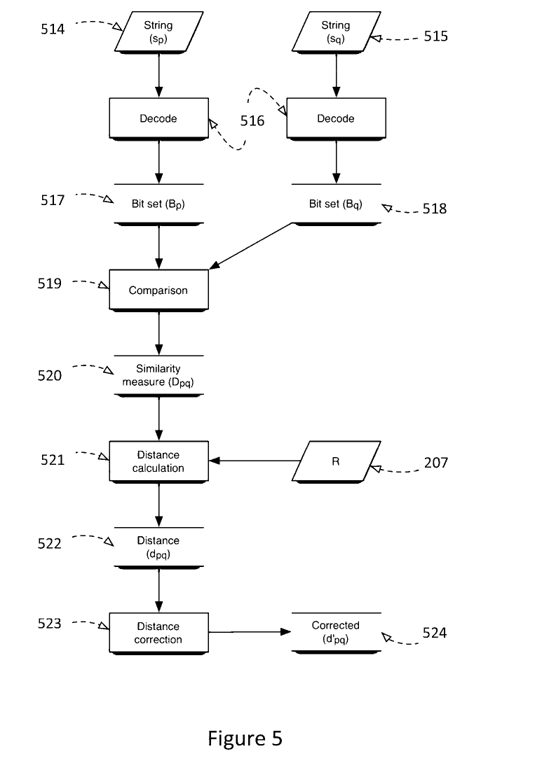

An example of the process for decoding and comparison of characterizing sets or strings for two records is shown in FIG. 5. In this example, the abstracted data from two records was encoded for transmission into two encoded stings Sₚ 514 and S_{q} 515 using reversible encoding. To compare the two records, the encoded strings are turned back into a collection of bits and these sets of bits compared to ascertain their degree of similarity.

Two encoded strings Sₚ 514 and S_{q} 515 are converted back into their representative bit sets Bₚ 517 and Bₚ 518 using a decoding process 516 which is the reverse of the encoding process 212.

These bitsets are compared using a comparison process 519 which provides a similarity measure D_{pq} 520 between the two sets.

For example, the ‘degree of similarity’ of two sets of bits representing two different locations p and q, say P=Bₚ and Q=B_{q} may be calculated using the Sørensen-Dice coefficient of the two sets. Given the two sets P and Q the degree of similarity s between the two sets may be calculated as

$$s = \frac{2 \vert P ⋂ Q \vert}{\vert P \vert + \vert Q \vert} \qquad Equation [ 2 ]$$

The intersection operation here is the bitwise operation ‘logical AND’ which sets a bit in the result only when the corresponding bit is set in both input sets, e.g. the logical AND of 001010110 and 011101010 is as follows

$$\frac{\begin{matrix}001010110 P \\ 011101010 Q\end{matrix}}{001000010 P ⋂ Q}$$

The cardinality of each set is given by the number of bits ‘on’ in each set. The cardinality of the above sets are as follows:

$$\frac{\begin{matrix}001010110 : \vert P \vert = 4 \\ 011101010 : \vert Q \vert = 5\end{matrix}}{001000010 : \vert P ⋂ Q \vert = 2}$$

The Sørensen-Dice coefficient of these two sets is 2×2/(4+5)= 4/9 ≅0.444, Calculated using Equation 2. This coefficient ranges from 0 when the sets have nothing in common to 1 when the sets are identical. This range of similarity corresponds to the range ‘no overlap between the circles’ to ‘the circles are congruent.’

This measure from [0, 1] may be used as is requiring no information from the encoding process to be needed to compare the similarity of hashed records. For example, this similarity measure D_{pq} 520 can be further converted back into a ‘distance’ measure d_{pq} 522 using a translation process 521 which takes into account the original radius R 207 used in the original calculations. If all that is needed is a similarity measure the value D_{pq} 520 can be used directly and no information from the original abstraction process need be used in the comparison process.

In two dimensions for the spatial case, the degree of overlap from [0, 1] corresponds to the area of overlap (0, πR²]. Since the area of overlap of two circles of radius R with a separation of d (for 0≦d<2R) is given by the bijection

$$A ( d ) = 2 {R}^{2} {cos}^{- 1} ( \frac{d}{2 R} ) - \frac{1}{2} d \sqrt{4 {R}^{2} - {d}^{2}} \qquad Equation [ 1 ]$$

knowing A gives us d.

In practice, rather than computing the inverse of this function the translation process 521 might use a piecewise linear approximation of the function to calculate the A⁻¹ with minimal error.

For example here are ordinates normalised for R for an equal subdivision of A⁻¹ over the range [0, 1], i.e. 0 (no overlap) gives a separation of 2 (representing 2R or greater) and 1 (total overlap) gives a separation of 0.

INTERPOLATION_VALUES=[2.0, 1.91691, 1.86778, 1.82637, 1.78926, 1.75502, 1.7229, 1.69241, 1.66326, 1.63521, 1.60809, 1.5818, 1.55621, 1.53125, 1.50686, 1.48297, 1.45955, 1.43655, 1.41393, 1.39167, 1.36974, 1.34811, 1.32677, 1.3057, 1.28487, 1.26428, 1.24391, 1.22375, 1.20379, 1.18401, 1.16441, 1.14498, 1.12571, 1.10659, 1.08761, 1.06877, 1.05006, 1.03148, 1.01302, 0.994677, 0.976443, 0.958314, 0.940288, 0.922358, 0.904523, 0.886777, 0.869118, 0.851542, 0.834046, 0.816627, 0.799282, 0.782008, 0.764803, 0.747664, 0.730588, 0.713574, 0.696619, 0.67972, 0.662876, 0.646085, 0.629345, 0.612653, 0.596008, 0.579409, 0.562853, 0.546338, 0.529864, 0.513429, 0.49703, 0.480667, 0.464338, 0.448042, 0.431777, 0.415542, 0.399335, 0.383156, 0.367003, 0.350874, 0.334769, 0.318686, 0.302625, 0.286583, 0.27056, 0.254555, 0.238566, 0.222593, 0.206634, 0.190689, 0.174756, 0.158833, 0.142921, 0.127018, 0.111124, 0.0952358, 0.079354, 0.0634772, 0.0476044, 0.0317346, 0.0158668, 0.]

Thus, calculating the degree of overlap gives a value in the range [0, 1] and passing it through the inverse function gives a value in the range [0, 2R]. No overlap, at which point it's impossible to determine how far apart the circles are, is also given by a result of 2R. At which point the conclusion is that the centres of the circles are a distance of 2R or greater apart.

Since the random nature of the hashing function in practice means that the similarity measure never usually reaches zero for any two sets but reaches a minimum ε (based on the probability of random collisions between the two sets) and thus the range of returned similarity values might lie in the range [ε, 1] thus a normalising or distance correction process 523 may need to be performed to take the ‘raw’ distance calculation d_{pq} to a correction distance value d′_{pq} 524.

For example, in two dimensions we may need to take the range [0, A⁻¹(ε)R] to [0, 2R]. Experiment has shown that a linear scaling correction may be sufficient here but other correction functions are possible.

In a first example the method of the invention is employed to enable distance between two locations to be determined without giving away the actual locations. For example this approach may be used in a social networking context to enable relative distance between two people or a person and a target location to be determined without having to share exact location data.

Instead of encoding a location explicitly as a set of coordinates it is encoded as a set of surrounding coordinates by drawing a circle (or other region) around the point and collecting together the multiple points of a randomly numbered regular grid contained within the circle. This encodes an explicit coordinate, which reveals location, as a collection of essentially random numbers, which in the absence of the knowledge of the numbering scheme does not reveal location explicitly.

Given a point, take a circle of radius R around the point. Overlay this circle on a coordinate grid. The grid may be a regular square Cartesian grid for a flat geometry such as a plane or for an approximately flat geometry such as a small region of the Earth's surface; for a larger region of the Earth's surface another regular grid may be used such as a triangular partitioning of the surface of the sphere. The important thing is that the grid is regular such that equal circles circumscribe a reasonably commensurate collection of grid points.

The use of a region which has rotational symmetry ultimately allows distance to be calculated without having to reveal exact location. The relative closeness of items may be determined without knowing their actual locations. For example, two users each characterise their locations using an area (say circle of radius R around their location) on the same template matrix, grid or lattice which may be private to these two users. Each user's location is characterised as a set of lattice identifiers which are randomly numbered coordinates of the lattice.

These randomly numbered coordinates are ‘hashed’ using a one-way function to a smaller set. Because the total number of points is likely to be prohibitively large, it may be reduced with no real loss of precision by using a one way function to take the large number of points on the original grid to a smaller number of bits which contains a reasonably larger number of points than would be contained within a circle. This hashing may use a function which gives a single value or multiple values, e.g. a Bloom filter

This hashed value or set may then be represented in some communicable form. For example, a bit string, a character string, bar code or QR code etc, the form chosen may vary depending on the medium and technology used for communication. For example, a QR code may be printed and read using a scanner on a mobile phone whereas a bit string may be directly transmitted between two devices. Different ways of representing the bit set may be used: they may be represented as a literal sequence of 0's and 1's; they may be encoded as transmission-safe character strings using different character encodings and character subsets within each coding, e.g. base64; they may be explicitly listed, e.g. {1, 456, 96, . . . }.

The communicated coded bit string can be decoded and the resulting string of bits may be compared in a bitwise logical fashion to determine the ‘overlap’ with another such string. This overlap corresponds to the amount to which the circles surrounding their corresponding location overlap. Knowing this degree of overlap allows the distance between the locations to be calculated without revealing the locations themselves.

The amount to which two similarly sized circles overlap can be used to determine how far apart their centres are. By comparing how many points of the underlying grid the circles have in common the level of overlap may be approximated (to any level of precision by increasing the resolution or ‘fineness’ of the underlying grid). So from a distance of 0 up to 2R (when the circles just touch) the distance between the centres of the circles may be approximated.

By encoding the points as an area and encoding them as a set of random numbers and then reducing that set of random numbers to a smaller set of bits it becomes impossible given just the final reduced bit set for a location to work backwards to reveal the exact location.

This new approach overcomes the problems of privacy: individual records no longer reveal any location information but can still be compared to give a very good indication of distance separation. A large amount of data may still allow locations to be approximated but it is computationally intensive and each individual record is no longer identifiable by location.

A third party is not required to do the comparisons between records. However, the comparisons may still be done by a third party if necessary to further protect privacy.

Precision is not lost by ‘uttering’ or aggregating up to a spatial region.

In a social media context, this would allow individual users to ‘know’ when a colleague or friend (or other device) is ‘nearby’ without revealing their exact location. Current implementations of things like ‘Find My Friends’ are an all-or-nothing affair showing someone's current location rather than just their proximity.

This technology may be used in a military or other secure privacy-significant context to encode the location of a vehicle or missile and therefore enable calculation of its distance-to-destination without revealing its location.

The comparisons may form a tiered structure of comparisons to provide arbitrary precision while still keeping the amount of data involved manageable, e.g. two bitsets may be handed out per location, say, P₁, P₂, Q₁ and Q₂ where P₁/Q₁ allow a coarse comparison say over a scale of km while P₂/Q₂ allow a finer grained comparison over a range of m and which is only guaranteed to be valid if the P₁/Q₁ comparison lies within a certain distance threshold.

Other variations may be employed to further protect privacy by customising the parameters employed during the abstraction process. For example, Different numbering systems may be used to number the points on the grid. Different hashing functions and methods may be used to hash the large set of grid point identifiers down to the smaller bit set. Different sized bit sets may be used. These variations may be applied on an ad hoc basis between pairs of recipients to maintain privacy of their comparison with respect to other comparisons.

Embodiments of the invention allow use of customised or application specific coordinate systems and template lattices to be generated using custom coordinate systems. This provides great flexibility for the application of embodiments of the invention. Further customised template lattices can be used between individuals, for specific purposes or regularly changed to enhance security. A predefined or commonly used coordinate system (such as geographic or geometric Cartesian coordinates) can also be used.

The first step for generating a template lattice is selecting or creating the coordinate system to use. The coordinate system can be n dimensions and typically n is greater than two. A lattice is then defined using the coordinate system. For example a regular two dimensional grid can be used for the distance determination example. However, for other types of analysis different matrix or lattice structures may be used and uniformity of lattice elements may not be essential for all applications. For example one dimension may use a logarithmic scale, another dimension or dimensions may be comprised of a set of possible letter pairs (bigrams) to be found in names or components of dates.

Each lattice element is defined by a set of coordinates in accordance with the n-dimensional coordinate system. Each lattice element is then assigned an identifier independent of the coordinate system, to provide a template lattice comprising a set of lattice elements, where each lattice element is defined by a set of coordinates corresponding to a position of the lattice element within the lattice and a lattice element identifier

Typically each identifier is also unique within the template lattice. The lattice identifier may be generated and assigned using a random or pseudo random number generating process. Lattice identifier may also be non-numeric, for example using collections of words, characters, symbols, images or patterns.

For a regular lattice each lattice element is defined by a set of coordinates equidistant in each of the n dimensions from neighbouring lattice elements. For example, a regular lattice will typically be used for distance determination for ease of conversion of overlap in characterising strings to actual distance.

Other variations are contemplated within the scope of the present invention. Appropriate regular grids may be substituted, e.g. for non-Euclidean geometries such as the surface of a sphere or the surface of the Earth. Instead of using a regular rectangular grid for a flat (or nearly flat) geometry a triangular subdivision of the sphere may be used. The technique may be expanded to multiple dimensions, e.g. hashing voxel identifiers within a sphere around a point in 3 dimensions.

Embodiments of the invention can apply to n dimensions and be used to provide comparisons on n-dimension non-spatial information.

The geometries need not both be circular. The distance from a line may be similarly computed by encoding a (rectangular) region around a line and computing the overlap between a circle and the rectangle and using that to calculate distance of the centre of the circle to the line.

When comparing the distance of a point to a line the comparison function needs to be altered slightly to that described above and the formula to be used becomes the area of overlap between a circle and a rectangle rather than two circles.

First, the comparison function computing the bitset intersection of the line set L and the circle set C is normalised on only with respect to the number of elements in the circle, i.e.

$$s = \frac{\vert C ⋂ L \vert}{\vert C \vert} \qquad Equation [ 4 ]$$

The area of overlap function is the area of the circular segment lying ‘inside’ the line region which is the same calculation as for the circle case: the circle case involves doubling this area, one for each circle as they protrude into each other.

Embodiments may also be used to abstract information to be compared as arbitrary regions of n dimensional space and the degree of overlap of those regions used as a measure of similarity of the underlying information.

For the general case of regions in an n-dimensional space we can arrive at a similarity measure using the symmetric equation, equation 1 above, to compare the two regions or use an asymmetric similarity measure similar to the line case:

$$s = P ⊗ Q \frac{\vert P ⋂ Q \vert}{\vert P \vert} \qquad Equation [ 5 ]$$

Note that P\textcircled{×} does not necessarily equal Q\textcircled{×} and the regions may be composed of unconnected sub-regions.

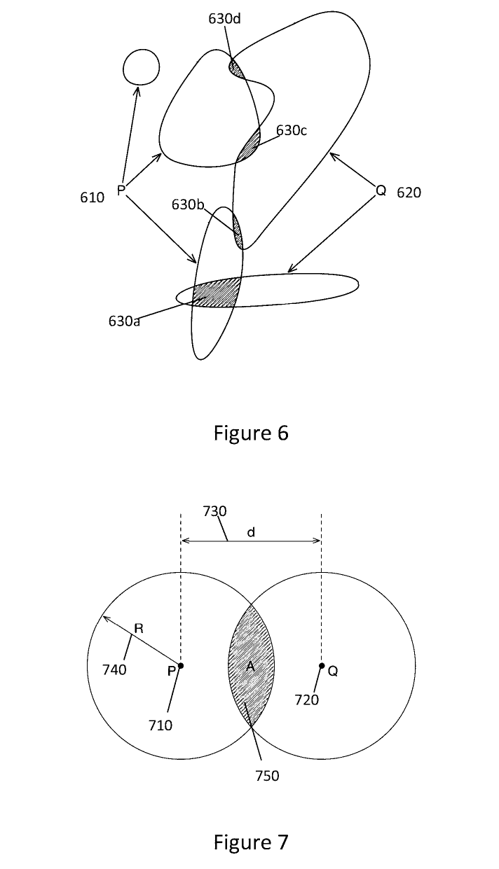

In two dimensional space this might be represented as shown in FIG. 6. Here we see disconnected regions P 610 and Q 620 and their overlap (shaded) 630a-d.

As an application of this several axes of the comparison space may be devoted to birthdate′ information, e.g. one axis for year, one for month and one for day. Given a year such as 1975 a region of elements in Q might be encoded around 1975 and smaller regions around 1957 and 75 and 1795. When an encoded region P containing 1975 is compared with Q it registers a ‘strong’ match as it overlaps a large region, if, however, P represents a record containing a transcription error, e.g. the year was incorrectly entered as 1957 by accidentally transposing digits, it will still match with Q but to a lesser extent as now it only overlaps a smaller region.

In the n-dimensional cases different axes may be devoted to different components of the records to be compared and those components encoded along those axes. For example, day/month/year dates may be mapped using a 3 dimensional coordinate system, day, month and year corresponding to each axis respectively.

A single dimensional application of this could be the encoding of height on, say, a passport. This biometric information could be encoded such that the underlying information would not be readily apparent from its representation but two heights may be compared with reasonable accuracy to determine a match. In this application, the characteristic point set consists of the set of lattice points in the interval [h−Δ, h+Δ] where h is the height to be encoded and A is a value giving a range of heights around the height of interest (equivalent to R in the 2-dimensional case).

An advantage of this method is that fuzzy or weighted matching may be achieved by encoding alternatives as geometries regions of different sizes in the coordinate space to allow different levels of match to be calculated.

As an application of this some components of an n-dimensional lattice may be devoted to year/month/day information in dates. A date such as Dec. 5, 1998 might be encoded with ‘large’ geometries representing the 12^{th} day, the 5^{th} month and the year 1998 while also including smaller geometries encoding the 5^{th} day and the 12^{th} month. When matching two dates which are both Dec. 5, 1998 all the larger regions will overlap and give a ‘strong’ match, however when matching Dec. 5, 1998 with May 12, 1998 (which has been encoded with ‘large’ regions at the 5^{th} day and 12^{th} month and smaller regions at the 12^{th} day and 5^{th} month) only they year will match strongly and the day and month will match weakly and give rise to a similarity measure which indicates a less good match but a better match than when only the year matches.

As a further application of this, alternatives representing other weaker matches may be mapped into the coordinate space and encoded.

This geometric approach provides an advantage over approaches which encode a fixed set of elements per data component even where multiple bits are set in the final bit set for each component.

The normalising factor in the comparison determination need not be related to P or Q. It might be a constant, e.g.

$$s = \frac{\vert P ⋂ Q \vert}{c} \qquad Equation [ 6 ]$$

where c helps weight the match and allows s to vary outside the range [0,1]. For example when |P∩Q|=c then s=1 but when |P∩Q|=2c then s=2 and we might have a ‘better’ match. For example, c might provide a weighting such that a match along one axes produces an s value around 1 but allows this value to go up the more elements match; if name and birth year match for example, s≈2 which gives an indication of a ‘better’ match than if just name or just birth year matched, where s≈1, or where nothing matches where s≈0.

Embodiments of the invention enable encoding of information such as a point as a set of elements (with random identifiers) equivalent to a continuous or disjoint area(s) or region(s) of an (abstract) multi-dimensional space to characterize the information without revealing what the underlying information is. Optionally this characterization can be hashed down to a smaller set.

Choosing different random naming schemes and hashing functions allows privacy between sets of data, i.e. two sets of data computed with different naming and hashing functions cannot be compared directly.

Using directly the similarity of the original or the hash bits sets to calculate the degree of overlap of the regions, and hence a distance separation in the 2-dimensional circle application of this method or a (possibly weighted) similarity measure in the general case, enables end user calculation of these values without necessarily involving a third party.

The comparative analysis is ‘accurate’ to a desired configurable level of accuracy while still maintaining privacy. The level of accuracy being configurable based size/distance between lattice elements of the template lattice used for abstracting the data for comparison. The function used for hashing characterizing data may also have some impact on accuracy. The hashing function discards some data from the original characterizing set of lattice identifiers leaving a small degree of uncertainty in the overlap determination. For example, two exact matching hashed bit sets may not represent all the exact same set of original lattice identifiers but the statistical likelihood is that the two original sets are the same or close enough to a complete overlap to consider them so. Conversely a comparison given, a very low number of elements in common may indicate a very small overlap or simply coincidental hashing of original element identifiers to the same hashed bit patterns, thus whether or not a small degree of overlap has occurred may be based on a statistical likelihood for the hashing function of coincidental similarity rather than just where or not there are any elements in common.

It should be appreciated that accuracy of the record linkage/comparison is a trade-off between including demographic or other information for meaningful linkage and removing/obscuring such information. Further, given enough data it may be possible to re-identify underlying data in some circumstances by comparison to a substantially similar known data set. For example, considering a 2-dimensional case, if one took a set of spatial data and simply reconstructed it via triangulation (a single point tells you nothing, two tells you how far apart the points are, three can determine 1 with respect to the other 2, and so on) one ends up with clusters of points. If the underlying data were, say, spatial then enough data may enable comparison to a known population density map, which may include some translation, rotation and scaling to overlay all of the cluster points to corresponding positions on the known population density map and start re-identifying locations. However, this would likely be computationally intensive, even more so for a multidimensional case (3-dimensional or greater). The possibility of reconstructing some of the original data is an artifact of the amount of information being given out rather than the manner in which it is being given out.

Where multiple data elements are being encoded, encoding all the data in one bit set rather than multiple bit sets for each data component provides some defence against ‘triangulating’ the data to re-identify as a distribution of data encoding a single component such as names is much easier to triangulate and re-identify against a given distribution of names than an encoding of many components as it requires more calculation and more sophisticated (and thus less readily available) reference data.

The risk of being able to reconstruct the original data may be mitigated by changing the lattice identifiers or hashing function periodically, or using different abstraction for different analysis as this may help guard against collecting enough data to be able to perform reconstruction as described above. Other strategies that may be employed to enhance data security and guard against reconstruction include, limited data release, additional obfuscation of data, only releasing data to trusted parties, using a secure processing environment, using a trusted third party etc.

Another advantage for applications of embodiments of this invention is the system can be ‘passive’ in that data may be given to a user and the user performs the calculations himself rather than having to involve a server or third party or encryption to ensure privacy.

Another advantage is that embodiments of the invention enable abstraction of any data to a form that may be comparatively analysed automatically by a computer. For example, enabling data that typically required intuitive or subjective analysis by people to be quantified and mapped for automatic analysis. Examples of such data may include psychological profiles, behavioural descriptions, image data etc. The ability to abstract data using n-dimensions for analysis can enable a number of different aspects of a description of medical, behavioural or physical conditions or properties to be extracted from a written description, for example using word recognition, and mapped in different dimensions, enabling multidimensional automatic comparison of records to determine areas of commonality between records, which may then be translated to appropriate measures for each dimension and provide insights for researchers. This may particularly be of use in areas where comparative analysis is difficult due to data volume.

### Example Workflow

The following is an example workflow comparing two point sets to ascertain separation distance. A functionally equivalent sequence of steps has been implemented in both the programming language Python and the statistical programming language R.

Step 1—Point selection: In this example the coordinates of two geospatial points in NSW, Australia will be used. The example coordinates were taken as Sydney 1120, (S): 33°52′04″ S/151°12′26″ E (−33.8678500, 151.2073200) and Wollongong 1140, (W): 34°25′26″ S/150°53′36″ E (−34.4240000, 150.8934500). Although the following calculations can be performed in the WGS84 coordinate system a Euclidean approximation will suffice for this example since the region to be considered is small enough. (The geographical distance between these points is 68.209 km. The Euclidean approximate distance between these points is 68.164 km: an error of 0.066%.)

Step 2—Grid generation: A rectangular grid overlay was generated in increments 0.02 for the coordinates from −36 . . . −31S and 148 . . . 153E consisting of 62500 randomly numbered points. A circle of radius 1 on this grid encompasses approximately 7854 points.

Step 3—Circle generation: The circles of radius 1 for each coordinate were generated. The Sydney (S) circle 1110 contained 7858 points, i.e. |Gₛ|=7858 and the Wollongong (W) circle 1130 contained 7856 points, i.e. |G_{w}|=7856. A situation similar to this is diagrammed in FIG. 11. The density of the grid points 1150 has been reduced for clarity but the circle 1110 surrounding Sydney 1120 and the circle 1130 surrounding Wollongong 1140 can be seen.

Step 4—Overlap calculation: The number of points in common between these two sets was calculated: |Gₛ∩G_{w}|=4715.

Step 5—Normalisation: These values give a Sørenson-Dice coefficient of approximately 0.600102. This allows the approximate overlap area to be computed as Â=1.88528. By solving for din (where R=1)

$$\hat{A} = A ( d ) = 2 {R}^{2} {cos}^{- 1} ( \frac{d}{2 R} ) - \frac{1}{2} d \sqrt{4 {R}^{2} - {d}^{2}}$$

we can ascertain an approximate value for d.

In Python a piecewise linear function (described earlier) was used to effect this. In R, the function uniroot in the stats package can be used to find a solution for this equation over the range [0,2].

This gives an approximation of d=0.6392339 ‘degrees’. A degree of longitude at 34° latitude is approximately 92385 m and a degree of latitude is approximately 110922 m. If we average these we get d=64.980 km, within 10% of the geographical distance.

### Additional Applications

An embodiment of this invention may be used to filter data both as a positive filter (where matches are retained) and as a negative filter (where matches are discarded).

In this embodiment the filter is also encoded an items which match the filter, i.e. overlap the encoded filter region are retained or discarded as appropriate.

Consider an example where medical records for disease outbreak are encoded in multiple dimensions representing both spatial and temporal aspects of the data. A filter for a specific region(s) and time(s) can be encoded as a region in the encoding space, e.g. all of a particular city spanning a particular month.

This filter can then be used to find matching encoded items in a positive sense which would represent all items encoded as occurring in that city during that particular month or in a negative sense by excluding all items from that city during that month. This might be desirable, for example, if data had to be excluded because of a known defect or quality issue or if it were unneeded for a particular purpose.

This would have an effect on data privacy (as it enables some characteristics of records to be identified) but would also maintain some privacy aspects. Such a filter would need to be created with knowledge of the original encoding parameters in order to be encoded correctly.

This technique can be expanded to create filters which ignore certain dimensions of the data. For example, consider the case of a uniform encoding of two spatial dimensional coordinates (x, y) and one temporal coordinate (t). The encoding of a space-time event (x, y, t) 950 analogous to the basic spatial encoding would be a sphere or ellipsoid in the encoding space centred on a certain place at a certain time. The desirability of matching would be represented by the eccentricity along the various axes 910, 920, 930. FIG. 9 shows this encoding with a projecting of the encoding down onto the XY plan to show its spatial extent.

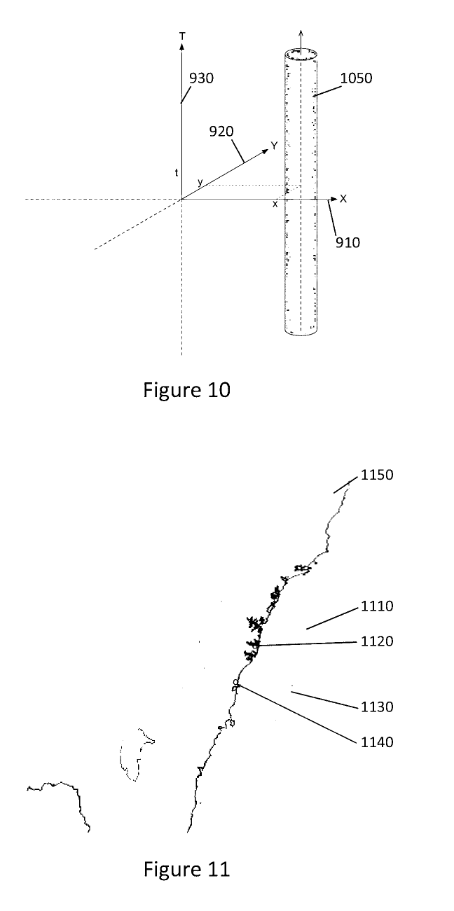

Encoding instead a cylinder, say, with an axis passing through (x,y) but which stretches entirely along the time (t) axis 930 would create a filter which could be used to fine (or exclude) all events which occurred in a particular place regardless of time. FIG. 10 shows this filter encoding with the filter cylinder 1050 stretching parallel to the time axis infinitely (to the limits of the encoding space) in both directions but limited in spatial extent; encoding a filter to allow matching of all event near (x,y) regardless of their temporal (t) location.

Such filters as described here need not be contiguous as described earlier and may consist of multiple disjoint regions. These examples are an encoding in 3 dimensions but the technique scales to more or fewer dimensions.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A computer implemented method of comparative analysis, the method comprising the steps of:
providing a template lattice as in input to computer implemented abstraction of data from records for comparative analysis, the template lattice comprising a pattern of lattice elements defined using an n-dimensional coordinate system, wherein each lattice element is assigned an identifier independent of the coordinate system;
abstracting data from each record for comparative analysis by a data abstraction module preforming for each record the steps of:
mapping one or more record data elements to a mapped position using the coordinate system; and
determining a plurality of lattice elements within a geometrically defined area of the lattice surrounding the mapped position and a set of lattice element identifiers associated with the plurality of lattice elements to provide a characterising set of for the mapped position;
comparing a first data record and a second data record by a record comparison module performing the steps of:
determining the degree of similarity between a first characterising set for the first record and a second characterising set for the second record; and
translating the degree of similarity to a comparison measure between the first record and second record based on the geometrically defined area used for abstracting data.

2. The method as claimed in claim 1 wherein the step of providing the template lattice comprises:
generating a lattice comprising a set of lattice elements using an n-dimensional coordinate system, where each lattice element is defined by a set of coordinates corresponding to a position of the lattice element within the lattice; and
assigning an identifier to each lattice element to provide the template lattice, each identifier being independent of the coordinate system and unique for the template lattice, whereby the template lattice comprises a set of lattice elements, each defined by a set of coordinates corresponding to a position of the lattice element within the template lattice and a lattice element identifier.

3. The method as claimed in claim 2 wherein the n-dimensional coordinate system is an application specific coordinate system, and wherein for at least one dimension coordinates of the one dimension correspond to a set of a plurality of possible non-numerical values for a data element enabling non-numerical values to be transposed to numerical values for geometrical analysis.

4. The method as claimed in claim 2 further comprising the step of changing the lattice element identifiers of the template lattice to provide a further template lattice.

5. The method as claimed in claim 2 wherein the lattice is a regular lattice where each lattice element is equidistant in each of the n dimensions from neighbouring lattice elements.

6. The method as claimed in claim 2 wherein the lattice element identifiers are generated using a random or pseudo random number generator.

7. The method as claimed in claim 1 wherein n is greater than one.

8. The method of claim 1 wherein the template lattice is a two dimensional lattice and the geometrically defined area used for characterizing a mapped position is a circle of a fixed radius.

9. (canceled)

10. The method as claimed in claim 1 wherein the abstracting step further comprises a step of encrypting the set of lattice element identifiers using a one-way encryption function provide a characterising string for the one or more record data elements, and the degree of similarity of the first characterising set and second characterising set is determined by comparing the encrypted strings of the first characterising set and the second characterising set.

11. The method of claim 10 wherein the one-way encryption function is a hashing function outputting the characterising string as a bit string.

12. (canceled)

13. The method of claim 1 wherein the abstracting step comprises a further step of encoding the characterising set using a reversible encoding and or compression function and the step of comparing a first data record and a second data record comprises an initial step of decoding the encoded characterising set for each of the first and second records.

14. The method of claim 10 wherein the abstracting step comprises a further step of encoding the characterising sting using a reversible encoding and or compression function and the step of comparing a first data record and a second data record comprises and initial step of decoding the encoded characterising string

15. The method as claimed in claim 1 wherein the n-dimensional coordinate system is a coordinate system is a geographical coordinate system and the degree of difference between the first record and second record is translated to a distance between a first geographical position and a second geographical position.

16. (canceled)

17. (canceled)

18. A system for comparative analysis, the system comprising:
a data abstraction module configured to abstract data of an input record based on a template lattice comprising a pattern of lattice elements defined using an n-dimensional coordinate system, wherein each lattice element is assigned an identifier independent of the coordinate system, by mapping one or more record data elements to a mapped position using the coordinate system, determining a plurality of lattice elements within a geometrically defined area of the lattice surrounding mapped position and a set of lattice element identifiers associated with the plurality of lattice elements to provide a characterising set; and
a comparator module configured to compare a first data record and a second data record by, determining a degree of similarity between a first characterising set for the first data record and a second characterising set for the second data record; and
a translator module configured to translate the degree of similarity output from the comparator module to a comparison measure between the first record and second record based on the geometrically defined area used for abstracting data.

19. The system as claimed in claim 18 further comprising a template lattice generator configured to define a lattice using a provided n-dimensional coordinate system where each lattice element is defined by a set of coordinates, and assign to each lattice element an identifier independent of the coordinate system and unique within the lattice to provide a template lattice comprising a set of lattice elements, where each lattice element is defined by a set of coordinates corresponding to a position of the lattice element within the lattice and a lattice element identifier.

20. (canceled)

21. (canceled)

22. The system as claimed in claim 18, wherein the data abstraction module is further configured to encrypt the characterising set of lattice element identifiers using a one-way encryption function provide a characterising string for each of the one or more record data elements, and the comparator module is configured to determine a degree of similarity between the first characterising set and second characterising set by comparison of the characterising strings.

23. The system as claimed in claim 15 where the positions involved are with positions with respect to some coordinate system other than a geospatial coordinate system.

24. The system as claimed in claim 23 wherein the translator module is further configured to perform distance correction of the translated distance by applying a correction function.

25. The system as claimed in claim 24 wherein the correction function is a linear scaling correction.

26. The method as claimed in claim 2 wherein the lattice is semi-regular and each lattice element is equidistant with respect to elements along some subset of the dimensional axes which comprise the coordinate system.
